(19) United States
(12) Patent Application Publication
(10) Pub. No.: US 2025/0382994 A1
(43) Pub. Date: Dec. 18, 2025

(54) CASING FOR FOOD APPLICATIONS

(71) Applicant: Aktiebolaget SKF, Göteborg (SE)

(72) Inventors: Andrea A BERTOLINI, Carrara (IT); Fausto BARACCA, Massa (IT); Dhanavel JOTHILINGAM, Pasur (IN); Mohammed IKRAMUDDIN, Bidar (IN)

(21) Appl. No.: 19/233,011

(22) Filed: Jun. 10, 2025

(30) Foreign Application Priority Data
Jun. 17, 2024 (IT) 102024000013831

(51) Int. Cl. F16C 35/04; F16C 33/06

(52) U.S. Cl. CPC F16C 35/045; F16C 33/06

(57) ABSTRACT

A casing (10) of a support assembly for food applications is made of composite material and has a housing portion (20). The housing portion has a through seat (25) which receives a bearing unit. A flange portion (30) fixes the casing to a machinery. The flange portion has at least one pair of through holes (32) for fastening elements and a surface (35) for contact with the machinery. A plurality of cavities (40, 50, 60, 70, 80, 90) are obtained inside the flange portion and are filled, by over-molding, with oil-free elastomeric material. The cavities include a curvilinear channel (90) and at least a pair of circular channels (60) which present a transverse section (ST) which includes a rectangular section (R) emerging on the surface and, more internal than the rectangular section (R) but adjacent to it, a section (SC) in the shape of a semicircle.

### CROSS-REFERENCE TO RELATED APPLICATION

This application claims priority to Italian Application No. 102024000013831, filed Jun. 17, 2024, the entirety of which is hereby incorporated by reference.

### FIELD

The present disclosure is related to a casing of a support assembly for food applications.

### BACKGROUND

In the food industry, hereinafter also F&B, from the English Food and beverages, there is a growing attention to the development of new machinery and machinery projects aimed at improving the safety and quality of food.

A typical component for these applications is a rotating shaft support assembly. The support assembly includes a casing made of polymeric material, compatible with food applications. The casing is provided with a spherical seat inside which a bearing unit is housed which in turn allows the rotation of a rotating machine shaft with respect to the casing. The casing, however, is a stationary component and is tightened to the frame of a machine. The casing includes a flange portion or base, which has its own surface in contact with the frame of the machinery and has numerous cavities that extend from the contact surface towards the inside of the flange portion. A shaped gasket in elastomeric material, also compatible with food applications, is overmolded in these cavities, which ensures the seal between the casing and the frame of the machinery so as to prevent possible infiltrations of water and bacteria from hiding behind the base of the supports. A hidden colony of bacteria that cannot be washed is evidently a major inconvenience for the F&B industry.

The elastomeric material used in F&B enclosures contains oil. When the casing is mounted to the frame, the seal is compressed and oil escapes from the elastomeric material creating the exudation effect. Even though it is a non-toxic substance, this oil spill is not welcomed by end users.

The phenomenon is very widespread: from tests carried out by the Applicant, all the casings showed similar results in terms of visibility of oil release, regardless of the production batch analyzed. Exudation was found in every test performed. The exudation appears to be caused by a combination of mechanical compression and volumetric constraints of the elastomeric material. Once compressed, in fact, the gasket tends to maintain its volume by expanding into the available free space. If it is not possible for the seal to retain its original volume, oil is released from the elastomeric material.

A solution to this technical problem is the use of “oil free” elastomeric material. This different material, if it solves the technical problem mentioned above, introduces another one. During the manufacturing process, the oil-free material is more difficult to over-mold on the polymeric material of the casing: the oil, in fact, during the injection of the elastomer makes it more fluid allowing it to fill all the cavities of the base of the casing used to receive the elastomer. To obtain the same filling, the pressure could be increased during the injection of the elastomeric material, but this countermeasure carries the real risk of inducing unacceptable deformations of the casing, making it impossible to insert the bearing unit into the spherical seat. Even in the case of deformations of a few tenths, the insertion of the bearing unit into the seat is considerably complicated and, consequently, the life of the support assemblies in general is affected.

### SUMMARY

To substantially solve the technical problems highlighted above, the present disclosure defines a casing, the flange portion of which has internal channels sized so as to allow the use of an oil-free elastomeric material.

Therefore, according to the present disclosure there is provided a casing of a support assembly for food applications having the characteristics set forth in the independent claim.

Further embodiments of the present disclosure, preferred and/or particularly advantageous, are described according to the characteristics set out in the attached dependent claims.

### BRIEF DESCRIPTION OF THE DRAWINGS

The present disclosure will now be described with reference to the attached drawings, which illustrate a non-limiting example of implementation, in which:

FIG. 1 is a cross section of a casing for food applications, according to a preferred embodiment of the present disclosure,

FIG. 2 is a bottom view of the casing in FIG. 1,

FIG. 3 illustrates, on an enlarged scale, a first detail of the casing in FIG. 1, and

FIG. 4 illustrates, on an enlarged scale, a second detail of the casing in FIG. 1.

### DETAILED DESCRIPTION

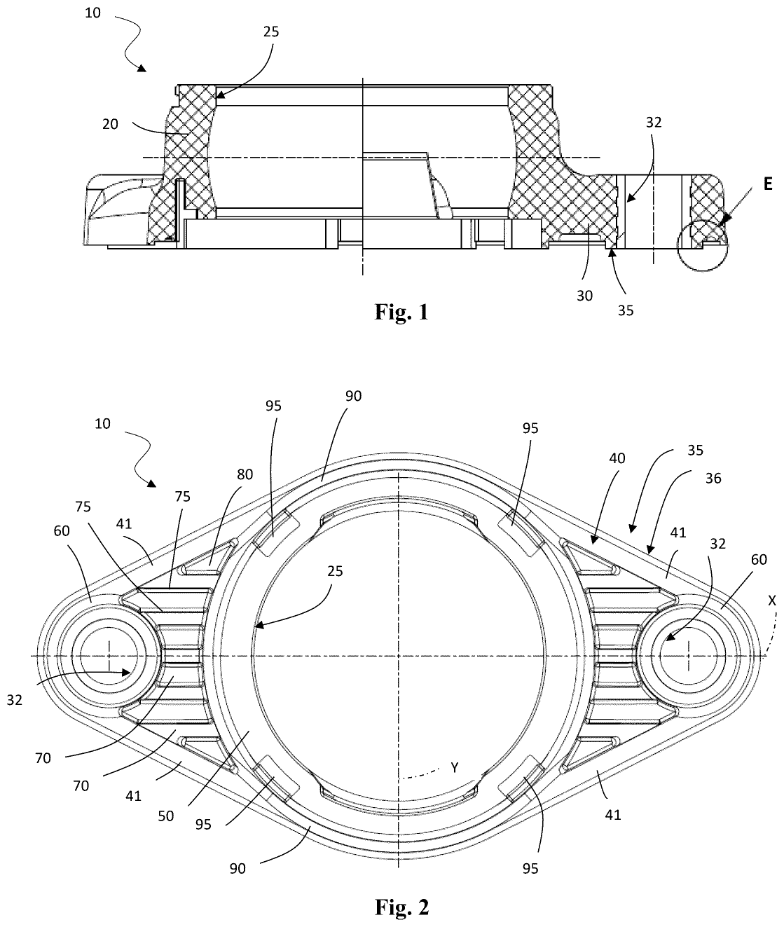

With reference to FIG. 1, a casing 10 of a support assembly for food applications comprises: a housing portion 20, annular, having a through seat 25 within which a bearing unit is received in a stable and known manner, and a flange portion 30 for fixing the casing to the machinery, presenting at least one pair of through holes 32 for housing in a known manner fastening elements, for example bolts, of the casing 10 to a frame of the machinery.

Referring to FIG. 2 too, the flange portion 30 has an X axis of longitudinal symmetry and a Y axis of transversal symmetry and is in contact with the machinery by means of a surface 35. The surface 35 of the flange portion 30 has a substantially rhomboidal and discontinuous shape in that a plurality of cavities branch out from the surface 35 towards the inside of the flange portion 30 which, by means of an over-molding process, are completely filled with an oil-free elastomeric material. Once the process is completed, therefore, the surface 35 takes on a substantially flat appearance, all its cavities being filled with the elastomeric material.

The cavities present on the surface 35 are:
a perimeter channel 40 adjacent to and included along the perimeter 36 of the surface 35. This channel includes four substantially rectilinear sections 41 which make up the sides of the rhomboidal figure of the surface 35,
a curvilinear channel 90 which connects and is in fluid connection with the sections 41 of the perimeter channel 40;
a circular groove 50 radially internal to the curvilinear channel 90 and which circumscribes the through seat 25 of the bearing unit. This circular groove 50 takes on the shape of a circular crown in plain view and defines a large volume that can be used by the elastomeric material,
at least one pair of circular channels 60, each of which circumscribes a through hole of the at least one pair of through holes 32 for housing the fastening elements. These circular channels 60 also take on the shape of a circular crown in plain view,
a plurality of longitudinal grooves 70, internal to the perimeter channel 40 and included, some, between the perimeter channel 40 and the circular groove 50, and, others, between the circular groove 50 and one of the circular channels 60. These grooves 70 are transversely separated from each other by corresponding ribs 75 of the flange portion 30 which present, like the grooves 70, a longitudinal pattern and are included, some, between the perimeter channel 40 and the circular groove 50 and, others, between the circular groove 50 and one of the circular channels 60,
a plurality of triangular slots 80, transversely external with respect to the longitudinal grooves 70 and included between the perimeter channel 40 and the circular groove 50.

All these cavities, 40, 50, 60, 70, 80, 90, as mentioned, by means of the over-molding process, must be perfectly filled by the elastomeric material that forms the gasket of the flange portion 30 of the casing 10.

To facilitate the filling of the aforementioned cavities, according to the present disclosure, a new section of the curvilinear channel 90 has been introduced. The same new section has also been introduced for the circular channels 60.

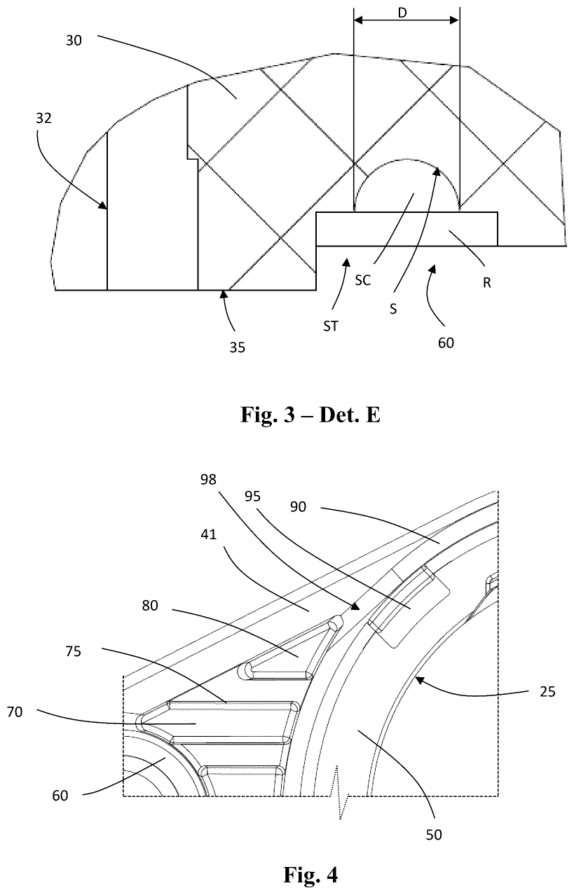

With reference also to FIG. 3, which refers to the circular channel 60 but can also be referred to the description of the curvilinear channel 90, the curvilinear channel 90 and the circular channels 60 have a wider cross-section ST compared to the section of the known solutions. In fact, the cross-section ST includes a rectangular section R emerging on the surface 35 and, more internal than the rectangular section R but adjacent to it, also a section SC in the shape of a semicircle. This further semicircular SC section, on the one hand, makes it possible, at the same injection pressure, to have a greater flow of elastomeric material, on the other hand, it is more advantageous compared to a rectangular section as it presents a greater ratio between area and perimeter S wetted by the material. In this way, the friction of the elastomeric material along the sliding surface of the channel is reduced and, consequently, the filling of the cavities occurs without having to increase the injection pressure. Keeping the dimensions of the casing unchanged, the diameter D of the semicircular section of the curvilinear channels 90 and the circular channels 60 can be approximately 2 mm.

Thanks to the use of this wider ST cross section and also including the semicircular SC section, the area of the curvilinear canal 90 and the circular canals 60 is more than doubled, with an increase of 110%. Furthermore, the ratio between the cross section of these channels and the wetted perimeter has an increase of approximately 50%.

Advantageously and with reference also to FIG. 4, the curvilinear channel 90 is in fluid connection with the circular groove 50 by means of a plurality of pockets 95. The pockets 95 can be four in number and can be obtained in symmetrical positions with respect to the axis X, Y. The greater cross section ST of the curvilinear channel 90, the more favorable area/wetted perimeter ratio and the passages made possible by the pockets 95 favor the elastomeric material to best fill the large volume of the circular groove 50 which surrounds the through seat 25 for the bearing unit.

Conveniently, the curvilinear channel 90 is in fluid connection with the triangular slots 80 by means of connected portions 97. The larger cross-section ST of the curvilinear channel 90, the more favorable area/wetted perimeter ratio and the presence of the connected portions 97 allows a greater flow of elastomeric material and therefore better filling of the triangular slots 80 as well.

Evidently, the ST cross section also including the semicircular SC section provides the same beneficial effects—better sliding of the elastomeric material—also for the circular channels 60 which circumscribe the through holes 32 for housing the elements fastening the casing to the frame of the machinery.

Finally, the greater cross section ST of the curvilinear channel 90 and of the circular channels 60, together with the more favorable area/wetted perimeter ratio, also favors better filling of the longitudinal grooves 70.

Ultimately, the present disclosure allows the use of an oil-free elastomeric material, thus avoiding the unwelcome phenomenon of exudation but at the same time guaranteeing excellent filling of the flange portion of the casing. And this effect is achieved without having to increase the injection pressure of the elastomeric material.

In addition to the embodiment of the present disclosure, as described above, it is to be understood that numerous other variants exist. It is also to be understood that such embodiments are exemplary only and limit neither the scope of the present disclosure, nor its applications, nor its possible configurations. On the contrary, although the above description allows the skilled person to carry out the present disclosure at least according to an exemplary embodiment thereof, it must be understood that many variants of the components described are possible, without thereby departing from the scope of the present disclosure, as defined in the attached claims, which are interpreted literally and/or according to their legal equivalents.

1. A casing of a support assembly for food applications, the casing comprising:
a housing portion having a through seat configured to receive a bearing unit;
a flange portion configured to connect the casing to machinery, the flange portion having an axis of longitudinal symmetry and an axis of transversal symmetry, the flange portion having first and second through holes for receiving fastening elements to connect the casing to the machinery, the flange portion having a surface arranged to contact the machinery when the casing is connected to the machinery; and
a plurality of cavities defined by the flange portion, the plurality of cavities configured to be filled, by over-molding, with oil-free elastomeric material, the plurality of cavities including:
a curvilinear channel radially external to the through seat; and
first and second circular channels, the circular channel surrounding the first through hole and the second circular channel surrounding the second through hole;
the curvilinear channel and the first and second circular channels each having a transverse section including a rectangular section emerging on the surface of the flange portion and a section in the shape of a semicircle, the section in the shape of semicircle being adjacent to and more internal than the rectangular section.

2. The casing according to claim 1, in which the plurality of cavities further comprises a perimeter channel provided with four straight sections connected by the curvilinear channel and in fluid connection with it.

3. The casing according to claim 1, wherein the plurality of cavities further comprises a circular groove radially internal to the curvilinear channel and which circumscribes the through seat of the bearing unit.

4. The casing according to claim 3, wherein the curvilinear channel is in fluid connection with the circular groove by means of a plurality of pockets.

5. The casing according to claim 4, in which the pockets are four in number and are obtained in symmetrical positions with respect to the axis of longitudinal symmetry and the axis of transversal symmetry.

6. The casing according to claim 2, in which the plurality of cavities further comprises a plurality of longitudinal grooves, internal with respect to the perimeter channel and transversely separated from each other by corresponding ribs of the flange portion.

7. The casing according to claim 6, in which the plurality of cavities further comprises a plurality of triangular slots, transversally external with respect to the longitudinal grooves and included between the perimeter channel and the circular groove.

8. The casing according to claim 7, in which the curvilinear channel is in fluid connection with the triangular slots by means of connected portions.

9. The casing of claim 1, wherein the casing is made of composite material.

10. The casing according to claim 2, wherein the plurality of cavities further comprises a circular groove radially internal to the curvilinear channel and which circumscribes the through seat of the bearing unit.

11. The casing according to claim 10, wherein the curvilinear channel is in fluid connection with the circular groove by means of a plurality of pockets.

12. The casing according to claim 11, in which the pockets are four in number and are obtained in symmetrical positions with respect to the axis of longitudinal symmetry and the axis of transversal symmetry.

13. The casing according to one of claims 12, in which the plurality of cavities further comprises a plurality of longitudinal grooves, internal with respect to the perimeter channel and transversely separated from each other by corresponding ribs of the flange portion.

14. The casing according to claim 13, in which the plurality of cavities further comprises a plurality of triangular slots, transversally external with respect to the longitudinal grooves and included between the perimeter channel and the circular groove.

15. The casing according to claim 14, in which the curvilinear channel is in fluid connection with the triangular slots by means of connected portions.

16. The casing of claim 15, wherein the casing is made of composite material.

17. A support assembly for food applications, the support assembly comprising:
a casing according to claim 16;
a bearing unit housed in a through seat of the casing; and
a cover.

18. A support assembly for food applications, the support assembly comprising:
a casing according to claim 1;
a bearing unit housed in a through seat of the casing; and
a cover.
